(19) United States
(12) Patent Application Publication
(10) Pub. No.: US 2007/0024714 A1
(43) Pub. Date: Feb. 1, 2007

(54) Whiteboard camera apparatus and methods

(76) Inventors: Sam Kim, Brush Prairie, WA (US); Larry D. Baker, Portland, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/192,943

(22) Filed: Jul. 29, 2005

(51) Int. Cl. H04N 5/225; H04N 9/04

(52) U.S. Cl. 348/207.99

(57) ABSTRACT

Disclosed are digital cameras adapted to capturing whiteboard images, and methods. Embodiments of the cameras incorporate processing firmware to create clear whiteboard images from digital images. Embodiments may also include a specialized lens for correcting for perspective effects, an interface for connection to a computer network, and provisions to facilitate semi-permanent mounting. Embodiments may also omit features commonly found on conventional digital cameras, such as a viewfinder; a memory card slot; a wide range of focus and shutter speeds; and on-camera controls; such that the cost of the whiteboard camera is reduced and the camera is rendered unattractive to theft.

### FIELD OF INVENTION

This invention relates generally to special-purpose digital cameras.

### BACKGROUND

Digital cameras are well-known in the art. In digital cameras, a lens system focuses light on an image sensor array, such as a charge-coupled device (CCD); the array senses the light and produces a digital image which may be transferred to another device for viewing, printing, editing, or storage.

Electronic whiteboards and copyboards are also known in the art, such as those manufactured by PLUS Vision Corporation and Quartet Manufacturing Company. These devices capture everything written on the board, which can then be printed, beamed to a personal digital assistant (PDA) or laptop computer, or posted on a network in color and in real-time. These devices are relative expensive, however, with larger sizes that are suitable for a conference room typically costing thousands of dollars.

A lower-cost alternative to electronic whiteboards is to photograph a conventional whiteboard using a digital camera, transfer the images to a personal computer, and use whiteboard software to reformat and clean up the images. One such software product is Whiteboard Photo™ software from Polyvision Company. This product adjusts the geometry of an image to provide a rectangular image of a whiteboard; sets the image background to white and enhance the contrast; and otherwise modifies the image to provide a clean and accurate whiteboard image.

While photographs taken with a standard digital camera can provide good whiteboard images after processing, taking the photographs may involve interrupting a meeting, and the additional steps involved in processing the images may discourage the practice. Standard digital cameras must also be secured against loss or theft, since they have many uses outside of the conference room.

There is thus a need for apparatus and methods that allow inexpensive and convenient capture of whiteboard images.

### SUMMARY

Exemplary embodiments of the invention include digital cameras adapted to capturing whiteboard images, and methods. Embodiments of the cameras incorporate processing firmware to create clear whiteboard images from digital images. Embodiments may also include a specialized lens for correcting for perspective effects, an interface for connection to a computer network, and provisions to facilitate semi-permanent mounting. Embodiments may also omit features commonly found on conventional digital cameras, such as a viewfinder; a memory card slot; a wide range of focus and shutter speeds; and on-camera controls; such that the cost of the whiteboard camera is reduced and the camera is rendered unattractive to theft.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates an exemplary whiteboard camera according to embodiments of the invention;

FIG. 2 is a block diagram further illustration an exemplary whiteboard camera according to embodiments of the invention;

FIG. 3 illustrates how a whiteboard may appear in an image captured by a conventional camera;

FIG. 4 illustrates the adjusted image provided by embodiments of the invention;

FIGS. 5(a), 5(b), 5(c), and 5(d) illustrate how various mounting positions for a whiteboard camera require perspective correction; and

FIG. 6 is a flow chart further illustrating an embodiment of the present invention.

### DESCRIPTION OF EMBODIMENTS

In the following specification, for purposes of explanation, specific details are set forth in order to provide an understanding of the present invention. It will be apparent to one skilled in the art, however, that the present invention may be practiced without these specific details. Reference in the specification to “one embodiment” or “an exemplary embodiment” means that a particular feature, structure, or characteristic described in connection with the embodiment is included in at least one embodiment. The appearance of the phrase “in one embodiment” in various places in the specification do not necessarily refer to the same embodiment.

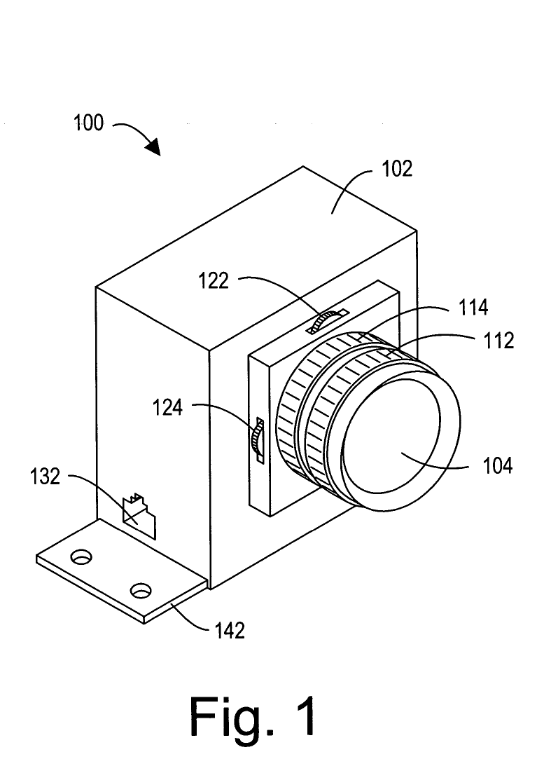

FIG. 1 illustrates an exemplary embodiment of a whiteboard camera 100. The camera has a body 102 which houses the image sensor (such as a charge coupled device—CCD—not visible) and processing electronics (not visible). Attached to the body is a wide angle lens 104. The lens may have manual controls for zooming 112 and focusing 114, or, alternatively, zooming or focusing may be automatic. The zoom and focusing ranges of the lens may be selected for best results in a conference room setting, and thus may be different than the zoom and focusing ranges of a conventional digital camera.

The lens may comprise a perspective control or “shift” lens, as is known in the art. Perspective control lens are common on medium and large-format cameras which are used, for example, in architectural photography. Perspective control lenses permit the optics of the lens to be moved perpendicular to the optical axis (in other words, shifted parallel to the camera body). In architectural photography shift lenses allow severe perspective effects, such as those that result from photographing a tall building from ground level, to be corrected.

As seen in FIG. 1, perspective control may be provided by manual controls in one or more axis, as indicated at 122 and 124, or perspective control may be automatic. Perspective control that changes the position of the lens side-to-side 122 with respect to the camera body 102 allows the whiteboard camera to be mounted near one end of a whiteboard while correcting the perspective to substantially rectangular. Perspective control that changes the position of the lens up and down 124 with respect to the camera body 102 allows the whiteboard camera to be mounted above or below a whiteboard while correcting the perspective.

Mechanical perspective control may substantially correct perspective errors, with any small remaining errors corrected by software manipulation of the images. In a whiteboard camera, a perspective control lens serves the additional function of preserving the pixel resolution over the whole of the whiteboard image. If the image of the whiteboard were severely compressed at one end due to perspective effects, correcting the compression solely through processing the resulting digital image may not provide completely satisfactory results, since the compressed portion has fewer camera pixels per inch of whiteboard in the compressed portion, and detail in this portion may be lost.

The exemplary whiteboard camera may also be adapted to interface with a computer through a Universal Serial Bus adaptor (not shown), or through an Local Area Network interface 132, such as Ethernet. In an embodiment having a LAN interface, the whiteboard camera is present at a network address where meeting participates may access and capture the whiteboard images. The LAN interface may be permanently wired, or temporarily connected, or accessed through a wireless connection.

The exemplary whiteboard camera 100 further includes apparatus for semi-permanently mounting the camera 142, which may be simple brackets, or may be more complex mechanisms that allow orienting or pointing the camera, as is known in the art.

A drawback with using a conventional digital camera to capture whiteboard images is that a general-purpose camera is subject to theft, since the camera is useful for other purposes. Embodiments of a whiteboard camera 100 may therefore lack certain common features that make more general-purpose cameras useful. For example, a whiteboard camera may dispense with a slot for digital memory; may have no built in viewfinder, such as an LCD (relying instead on monitoring the image on a computer screen for adjustment); and may have a very limited focal range (for example, focus may be limited to ranges normally encountered in conference rooms, such 20 feet). The camera may also have long exposure times, which would preclude “hand held” shots, to allow for sharper exposures using a “stopped down” lens in a conference room setting.

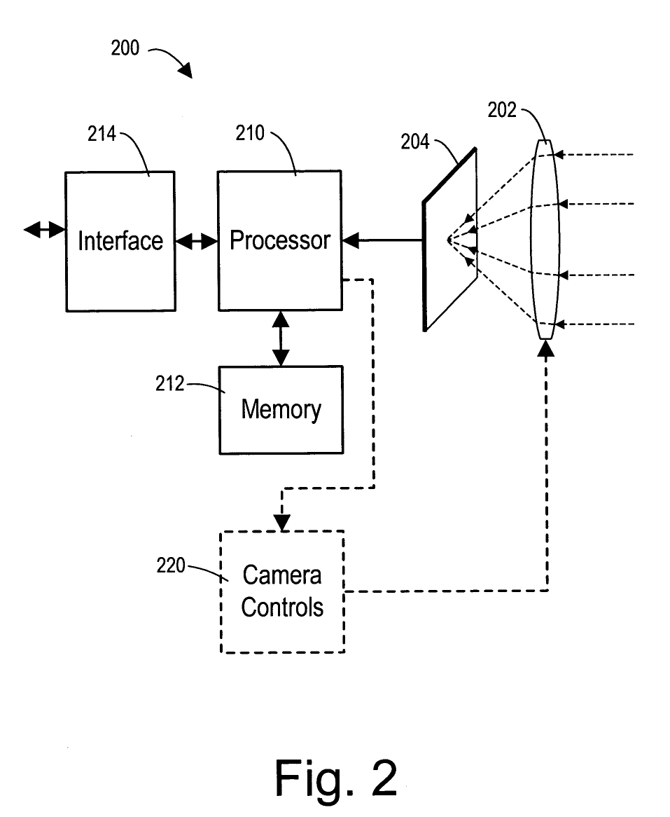

FIG. 2 is a block diagram further illustrating an exemplary whiteboard camera 200. The exemplary camera has a lens system 202 which focuses an image on an image sensor 204. The captured image is then transferred to a processor 210 which performs the image modification functions of embodiments of the invention. The processor 210 is electrically connected to memory 212, which may include both volatile and non-volatile memory; the non-volatile memory may include firmware to implement the methods of the invention. The processor also formats data for transfer to an external device, such as a computer network, through interface circuitry 214. The formatted data may be, for example, a common picture format such as Joint Photographic Experts Group (jpeg) or bitmap (bmp). If some or all of the camera controls are automated, the processor may also receive commands from the interface 214 and control the automated features, such as zoom and focus, through camera control circuitry 220.

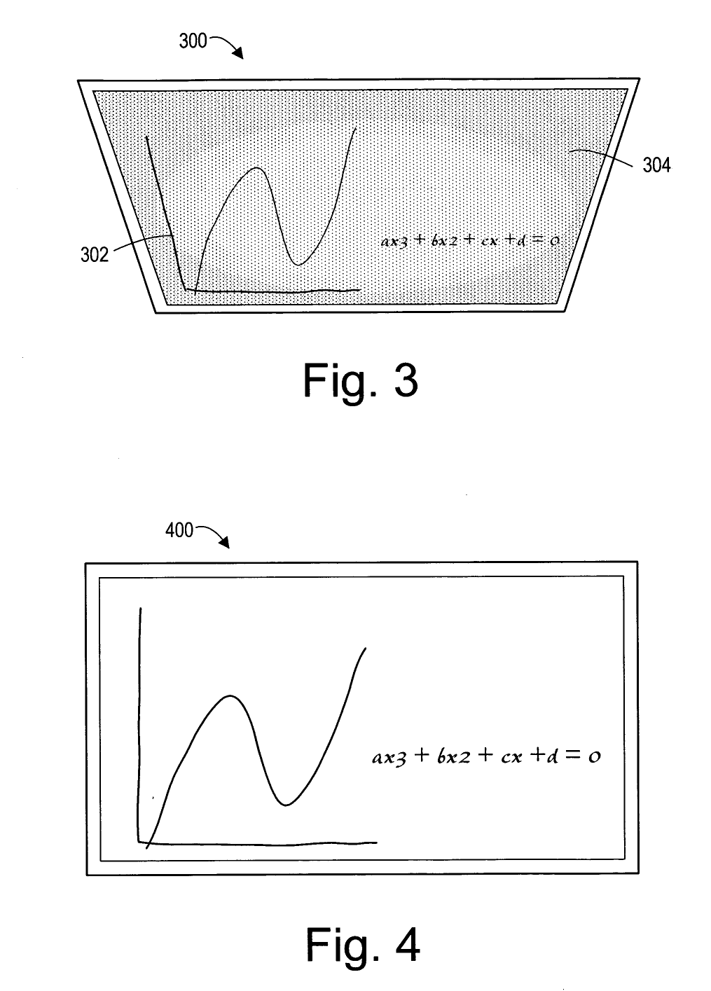

FIG. 3 illustrates a typical uncorrected image of a whiteboard. It may be observed that the image suffers from perspective effects, such as would be observed if a camera were positioned above the white board. The image includes material written on the whiteboard 302 and a background 304. The whiteboard background may not be subject to uniform illumination, causing portions of the image to be dark and difficult to observe. The foreshortening caused by perspective effects also causes objects at the more distant portion of the whiteboard to be reduced in size, and the reduced resolution may preclude reading this portion of the whiteboard image.

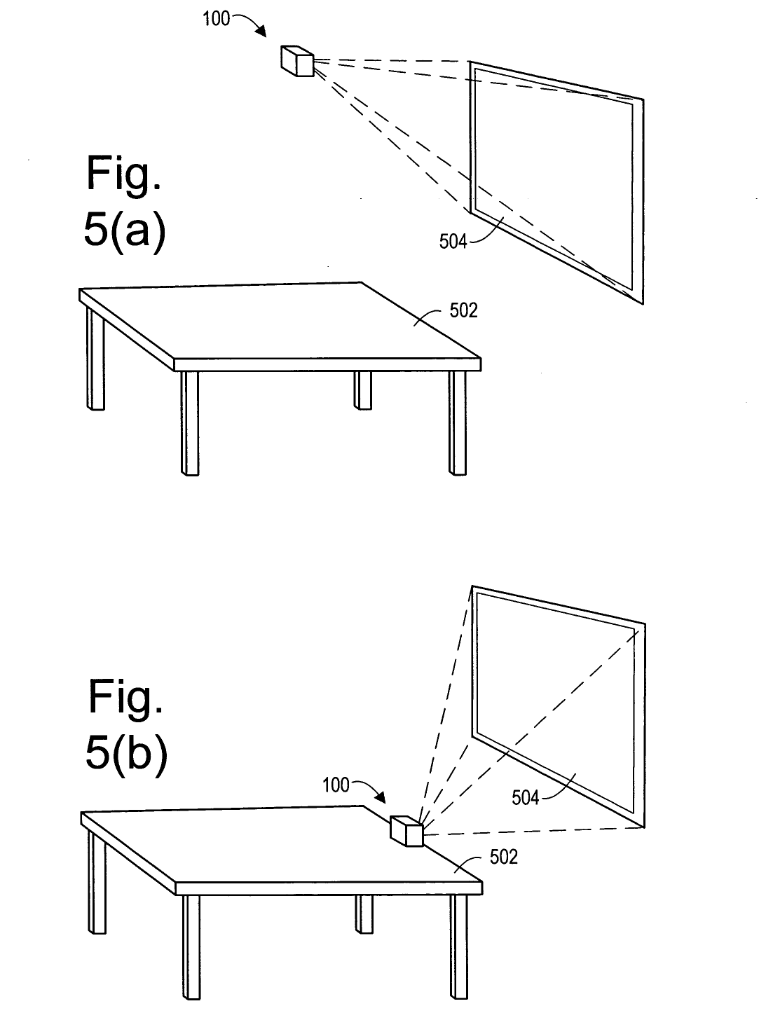

FIG. 4 illustrates a typical corrected whiteboard image according to embodiments of the invention. The image is corrected to rectangular, which may be achieved in part by the mechanical shifting of the perspective control lens and part by firmware routines (or, alternatively, the correction may be achieved solely by the mechanical lens shift or solely by firmware). The firmware routines also identify the background portions of the whiteboard and correct the background to a uniform white. The firmware routines may also sharpen the image, improve the contrast or hue, and remove artifacts, as is known in the art.

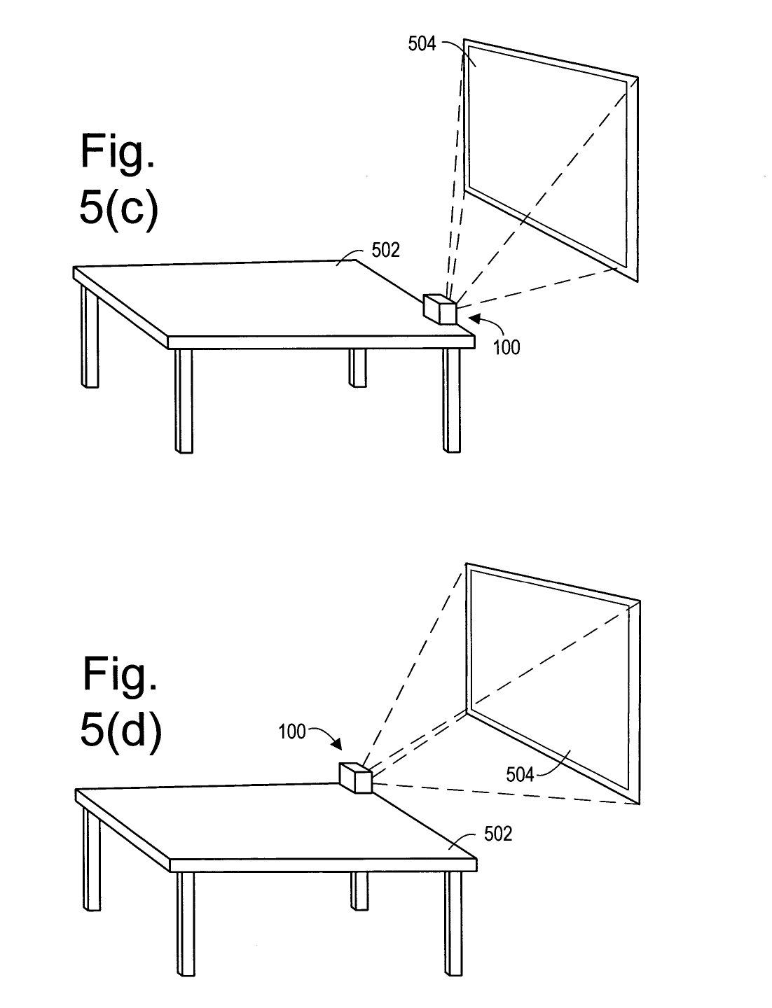

FIGS. 5(a), 5(b), 5(c), and 5(d) illustrate how an exemplary whiteboard camera 100 may be positioned with respect to a whiteboard 504. The whiteboard camera may, for example, be mounted above a whiteboard (FIG. 5(a)); may be positioned in front of the whiteboard, such as on a conference table 502 (FIG. 5(b)); or may be positioned to one side of the whiteboard (FIGS. 5(c) and 5(d)). In operation, the whiteboard camera may have network address and be connected to a local area network (LAN), such that meeting participants using laptop computers may access and capture whiteboard images “real time” from the network address. Alternatively, the camera may receive commands from the network, such as from a meeting chairperson, which causes an image to be obtained and processed.

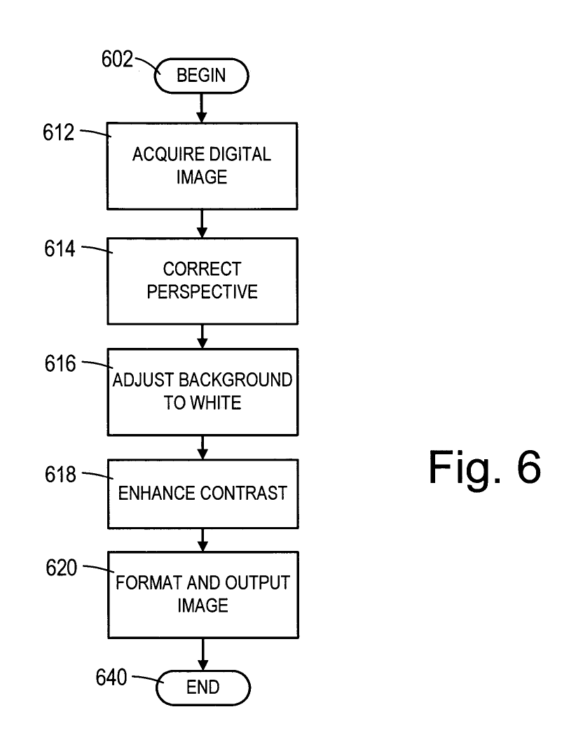

FIG. 6 is a flowchart illustrating an exemplary method of the invention. The method begins 602 with the acquiring of a digital image 612 by the camera. If firmware correction of the perspective is required, the perspective is corrected 614; the background is identified and corrected to a uniform white 616; contrast is enhanced and other image correction or improvement is performed 618, the image is formatted for output to a external device 620 such as a computer network, and the method ends 640.

The above is a detailed description of particular embodiments of the invention. It is recognized that departures from the disclosed embodiments may be within the scope of this invention and that obvious modifications will occur to a person skilled in the art. It is the intent of the applicant that the invention include alternative implementations known in the art that perform the same functions as those disclosed. This specification should not be construed to unduly narrow the full scope of protection to which the invention is entitled.

The corresponding structures, materials, acts, and equivalents of all means or step plus function elements in the claims below are intended to include any structure, material, or acts for performing the functions in combination with other claimed elements as specifically claimed.

What is claimed is:

1. A digital camera for capturing whiteboard images, comprising:
a camera body;
a lens mounted to the camera body;
an image sensor contained within the camera body; and
a processor contained within the camera body, the processor adapted to receive images from the image sensor and correct the perspective of the images, and to identify the background portion of the images and correcting the background to a uniform color.

2. The digital camera for capturing whiteboard images of claim 1, wherein the processor further is adapted to format the images and output them to an external device.

3. The digital camera for capturing whiteboard images of claim 2, wherein processor is adapted to output images to a computer network.

4. The digital camera for capturing whiteboard images of claim 1, wherein the lens is a perspective control lens.

5. The digital camera for capturing whiteboard images of claim 4, wherein the lens may be moved side-to-side with respect to the camera body.

6. The digital camera for capturing whiteboard images of claim 4, wherein the lens may be moved up and down with respect to the camera body.

7. The digital camera for capturing whiteboard images of claim 4, wherein the lens may be moved both side-to-side and up and down with respect to the camera body.

8. The digital camera for capturing whiteboard images of claim 1, wherein the lens is a wide angle zoom lens.

9. The digital camera for capturing whiteboard images of claim 1, further comprising apparatus for semi-permanently mounting the camera.

10. The digital camera for capturing whiteboard images of claim 1, wherein the camera does not have a viewfinder.

11. The digital camera for capturing whiteboard images of claim 1, wherein the camera does not have a memory card slot.

12. A digital camera for capturing whiteboard images, comprising:
a camera body;
a wide-angle perspective-control lens mounted to the camera body;
an image sensor contained within the camera body;
a processor contained within the camera body, the processor adapted to receive images from the image sensor and correct the perspective of the images, to identify the background portion of the images and correcting the background to a uniform color, and to output the images to an external device; and
apparatus for semi-permanently mounting the camera.

13. The digital camera for capturing whiteboard images of claim 12, wherein processor is adapted to output images to a computer network.

14. The digital camera for capturing whiteboard images of claim 12, wherein the wide-angle perspective-control lens may be moved both side-to-side and up and down with respect to the camera body.

15. The digital camera for capturing whiteboard images of claim 12, wherein the camera does not have a viewfinder.

16. The digital camera for capturing whiteboard images of claim 12, wherein the camera does not have a memory card slot.

17. A method of capturing images of a whiteboard, comprising:
with a digital camera, acquiring a digital image of the whiteboard;
within the camera, processing the digital image to correct for perspective and to make the image background a uniform color.

18. The method of capturing images of a whiteboard of claim 17, further comprising formatting the processed image and outputting the formatted image to an external device.

19. The method of capturing images of a whiteboard of claim 18, wherein the external device comprises a computer network.

20. The method of capturing images of a whiteboard of claim 17, further comprising substantially correcting the image for perspective with a perspective control lens before acquiring the digital image.
